(19) United States
(12) Patent Application Publication
(10) Pub. No.: US 2008/0006197 A1
(43) Pub. Date: Jan. 10, 2008

(54) Unmanned Underwater Vessel

(75) Inventors: Detlef Lambertus, Osterholz-Scharmbeck (DE); Christian Hucking, Bremen (DE); Ralf Richter, Oyten (DE)

Correspondence Address: FITCH, EVEN, TABIN & FLANNERY, P. O. BOX 18415, WASHINGTON, DC, 20036, US

(73) Assignee: Atlas Elektronik Gmbh, Bremen (DE)

(21) Appl. No.: 11/667,478

(22) PCT Filed: Dec. 2, 2005
(86) PCT No.: PCT/EP05/12910

§ 371 Date: May 10, 2007

(30) Foreign Application Priority Data
Dec. 23, 2004 (DE) 10 2004 062 124.1

(51) Int. Cl. B63G 8/00; B63G 8/16; B63G 8/41; G03B 42/06

(52) U.S. Cl. 114/313; 114/322; 114/330; 114/337; 367/11

(57) ABSTRACT

In a device and a method for tracking an underwater vehicle (11), a platform (13) having a tracking apparatus (15) for determining instantaneous positions of the underwater vehicle (11) is inserted into the water and its submerged position is spatially stabilized. To this end, the platform (13) has maneuver drives (18, 19) which act horizontally and vertically and are arranged in control loops.

The invention relates to a device and a method for tracking an underwater vehicle of the generic type defined in the precharacterizing clause of claim 1 and claim 7.

A known tracking system which is based on the SSBL (supershort baseline) principle (Simrad HPR-309 Hydroacoustic Position Reference System, Operator's Manual 3rd Edition October 1983, SIMRAD Subsea A/S, March 1985) comprises two components. One component is a transponder/responder, which is arranged on the underwater vehicle and, for its part, emits sound pulses, which are preferably coded, in response to the reception of sound pulses, which are preferably coded, or electrical transmission pulses, and a tracking apparatus, which is arranged on a platform and has an acoustic and/or electrical transmitter and a sound receiver, the sound receiver having two hydrophones which are arranged at a distance from one another. When tracking the underwater vehicle, acoustic or electrical interrogation pulses are continuously transmitted into the water by the transmitter or via a connecting wire to the underwater vehicle and are received by the transponder/responder on the underwater vehicle. For its part, the transponder/responder emits a response pulse in response to each interrogation pulse, said response pulse being received by the two hydrophones of the receiver of the tracking apparatus with a certain time difference. The direction-finding angle with respect to the underwater vehicle is calculated from the phase shift between the electrical output signals from the hydrophones and the distance between the underwater vehicle and the platform is calculated from the measured time which elapses between the transmission of the interrogation pulse and the arrival of the response pulse emitted by the transponder/responder in response to said interrogation pulse, taking into account a system time delay associated with the transponder/responder. Direction-finding and the distance reveal the position of the underwater vehicle relative to the position of the platform.

In a system for tracking down and destroying sea mines (EP 0 535 044 B1), the underwater vehicle which is equipped with an explosive charge is remotely controlled from a platform which floats underwater and the position of the underwater vehicle is continuously determined using a tracking apparatus which is arranged on the platform and operates in the manner described above. The platform has a deployment apparatus for inserting the underwater vehicle into the water. The platform itself is a so-called ROV or an unmanned underwater vehicle which is connected to the platform via a cable but may also be an auxiliary ship which is physically removed from a mother ship and communicates with the latter.

In the case of such a system, precise tracking of the underwater vehicle with accurate measurement of the respective vehicle position is possible only to a limited extent since the platform in the water is exposed to considerable interfering variables, for example swell, water current, which continuously change the position and acoustic orientation of the tracking apparatus, which, in extreme cases, may also result in a loss of the acoustic connection to the underwater vehicle.

The invention is based on the object of providing a device and a method for tracking an underwater vehicle which reliably preclude the risk of a loss of the acoustic connection between the underwater vehicle and the tracking apparatus and ensure highly precise detection of the position of the underwater vehicle, while tracking the underwater vehicle, even under unfavorable conditions.

According to the invention, the object is achieved by means of the features in claim 1.

The inventive device and the inventive method have the advantage that, as a result of the active spatial stabilization, the platform retains not only its position but also its orientation about the yaw axis, pitch axis and roll axis, with the result that both the position and the acoustic orientation of the tracking apparatus are kept constant and measurement errors when measuring the position, which errors are caused by position movement and a change in the acoustic orientation, are thus at least minimized. Even in the case of heavy swell or extreme current, any offset in position and orientation is compensated for and, in particular, the loss of the acoustic connection between the tracking apparatus and the underwater vehicle is also reliably prevented. The inventive tracking device is suitable for any submerged depth of the platform and underwater vehicle, even for use at depths of greater than 20 m.

Expedient embodiments of the inventive device together with advantageous developments and refinements of the invention emerge from claims 1 to 6 and expedient embodiments of the inventive method together with advantageous developments and refinements of the invention emerge from claims 8 to 11.

According to one advantageous embodiment of the invention, the platform is equipped with maneuver drives which act horizontally and vertically and are incorporated in control loops. These individually controllable maneuver drives can be used to stabilize the platform in a very precise manner as regards the three orthogonal spatial axes, that is to say in position and in the adopted orientation about the roll axis, pitch axis and yaw axis. Four horizontal drives, which are arranged such that they are uniformly distributed about the longitudinal axis of the platform at a radial distance from the longitudinal axis and can also be used to move the position of the platform, and one vertical drive which is arranged at right angles to said horizontal drives are sufficient in this case.

The invention will be described in more detail below with reference to an exemplary embodiment which is illustrated in the drawing, in which, in a diagrammatic illustration:

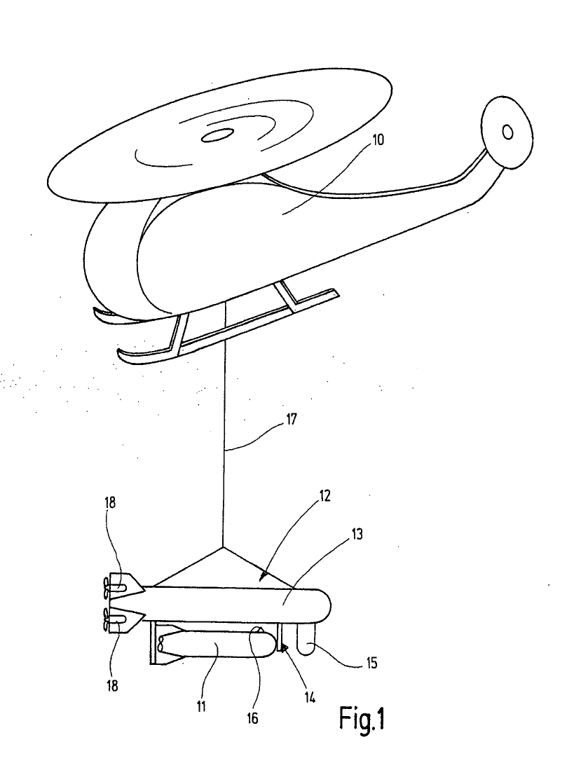

FIG. 1 shows a side view of an underwater vehicle, which is connected to a tracking device, when it is being lowered from a carrier vehicle, and

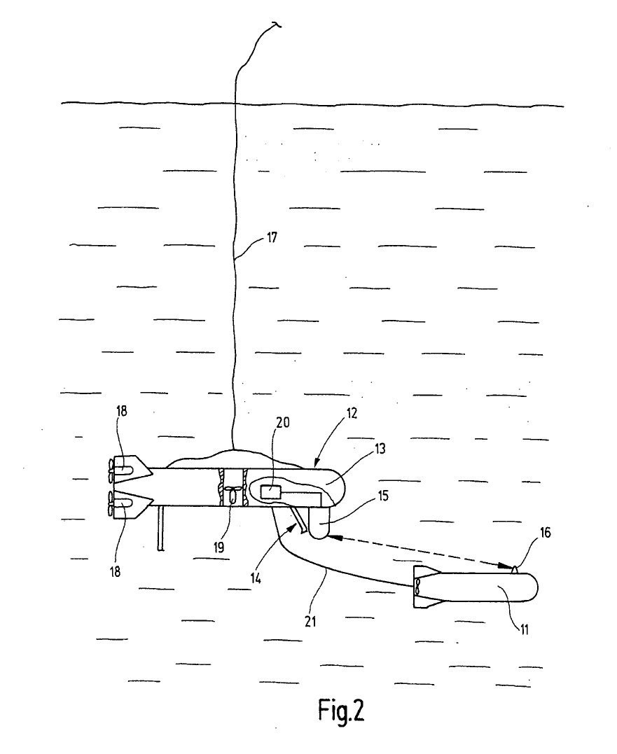

FIG. 2 shows a side view of the underwater vehicle and the tracking device after the end of the lowering operation.

A self-propelled unmanned underwater vehicle is used for a multiplicity of different underwater missions, said vehicle carrying out its mission either autonomously or being remotely controlled during its mission and transmitting data which are recorded during the mission to a carrier vehicle via a signal line. Such missions are, for example, the cartographical recording of the topography or nature of the seabed, the tracking-down of objects in the sea area or on the seabed and the recovery or removal of these objects. The underwater vehicle is set into the water, in the sea area to be investigated, by a carrier vehicle and the underwater vehicle which travels along is tracked using a tracking device so that the instantaneous position of the underwater vehicle is known at any time in the carrier vehicle.

In the exemplary embodiment illustrated in FIG. 1, the carrier vehicle is a helicopter 10 which inserts the underwater vehicle 11 together with the tracking device 12 into the water. Alternatively, the carrier vehicle may also be a surface ship or a submarine.

The tracking device 12 has a platform 13 which is equipped with a deployment apparatus 14 for lowering the underwater vehicle 11 underwater and with a tracking apparatus 15 which continuously detects the position of the underwater vehicle 11 which has been started and is moving away from the platform 13. As is not described in any more detail, in the exemplary embodiment, the tracking apparatus 15 is an APS (acoustic positioning system) system which communicates with a transponder/responder 16 on the underwater vehicle 11, operates, for example, on the basis of the SSBL principle described at the outset in relation to the prior art and has a transmitter for transmitting acoustic interrogation pulses during transponder operation and electrical interrogation pulses during responder operation as well as an electroacoustic receiver. The latter has at least two hydrophones which are arranged at a distance from one another and receive the response pulses transmitted by the transponder/responder 16 in response to the interrogation pulses. An evaluation unit uses the phase shift between the hydrophone signals to calculate the direction with respect to the underwater vehicle and uses the propagation time measurement of the transmitted sound pulses to calculate the distance with respect to the underwater vehicle.

During the lowering operation illustrated in FIG. 1, the underwater vehicle 11 is held in the deployment apparatus 14 of the platform 13 and the platform 13 is fastened to a rope or cable 17 which is lowered in order to insert the tracking device 12 together with the underwater vehicle 11 into the water using a cable winch (which is not illustrated here) in the helicopter 10. The cable 17 contains at least one signal line for interchanging data between the tracking device 12 and the helicopter 10. When a prescribed submerged depth of the tracking device 12 is reached, the underwater vehicle 11 is separated from the platform 13 by activating the deployment apparatus 14 and moves away from the platform 13 after its drive has been started (FIG. 2).

A plurality of horizontally acting maneuver drives 18 (a total of four such maneuver drives 18 in the exemplary embodiment) and one vertically acting maneuver drive 19 are provided on the platform 13. The maneuver drives 18, 19 which can be controlled separately are incorporated in control loops together with sensors (not illustrated here) for detecting interfering variables from the platform surroundings. When the horizontally acting maneuver drives 18 are operating in synchronism, the platform 13 can be moved forward and backward in the longitudinal direction and can be vertically raised up or lowered down using the vertically acting maneuver drive 19. Driving the horizontally acting maneuver drives 18 in a different manner allows the platform 13 to also be rotated in its yaw and pitch axes. The maneuver drives 18, 19 are arranged in control loops together with sensors for detecting controlled variables. These controlled maneuver drives 18, 19 are now used to spatially stabilize the submerged position of the platform 13, i.e. to compensate for movement components which change the orientation and position of the platform 13 in the three orthogonal spatial coordinates. As a result of this spatial stabilization of the platform 13, the latter not only retains its position but all of its movements about the yaw axis, roll axis and pitch axis are also compensated for. As a result, the hydrophones of the tracking apparatus 15 keep their position and orientation unchanged at any time when tracking the underwater vehicle 11 which is moving away from the platform 13 and the instantaneous positions of the underwater vehicle 11 are measured in a highly precise manner, to be precise even when the platform 13 is exposed to heavy swell or considerable longitudinal or transverse current.

The tracking operation, including determination of the direction with respect to the underwater vehicle 11 and the distance between the underwater vehicle 11 and the tracking apparatus 15, is carried out as described at the outset in relation to the prior art. The position of the underwater vehicle 11 relative to the platform 13 is thus known at any time during the underwater travel of the underwater vehicle 11. Since the absolute position of the platform 13 and thus that of the tracking apparatus 15 are known, the relative position coordinates of the underwater vehicle 11 can be converted without any problems into absolute position coordinates.

The described device for tracking the underwater vehicle 11 may be extended by a steering apparatus 20 which generates steering signals for the underwater vehicle 11 which are transmitted to the drive and control device of the underwater vehicle 11 via a steering wire 21 which connects the underwater vehicle 11 to the steering apparatus 20 and is preferably a glass fiber cable or a copper wire. The electrical interrogation pulses are also transmitted via this steering wire 21 during responder operation of the tracking apparatus 15 and transponder/responder 16. The input of the steering apparatus 20 is connected to the output of the tracking apparatus 15, with the result that the instantaneous positions of the underwater vehicle 22 which are determined by the tracking apparatus 15 are continuously available for the steering apparatus 20. The steering apparatus 20 compares the instantaneous positions with a position (which is stored in it) of an underwater object and uses the differences in position to generate steering signals for the underwater vehicle 11. These steering signals are used to guide the underwater vehicle 11 to the position of the underwater object using the shortest route.

1. A device for tracking an underwater vehicle (11), said device having a submerged platform (13) which has a tracking apparatus (15) that determines instantaneous positions of the moving underwater vehicle (11), characterized in that the platform (13) is formed such that its submerged position can be spatially stabilized and, to this end, has maneuver drives (18, 19) which act horizontally and vertically and are arranged in control loops.

2. The device as claimed in claim 1, characterized in that four horizontal maneuver drives (18), which are arranged such that they are uniformly distributed about the longitudinal axis at a radial distance from the latter, and at least one vertical maneuver drive (19) are arranged on the platform (13) and can be individually controlled.

3. The device as claimed in claim 1, characterized in that the platform (13) is designed such that it can be lowered into the water by a carrier vehicle (10) and the platform (13) and carrier vehicle (10) are connected to one another by means of a cable (17) which has at least one signal line for interchanging data.

4. The device as claimed in claim 1, characterized in that the platform (13) has a deployment apparatus (14) for lowering the underwater vehicle (11).

5. The device as claimed in claim 1, characterized in that the underwater vehicle (11) has a transponder/responder (16) which transmits acoustic response pulses in response to interrogation pulses, and in that the tracking apparatus (15) has a transmitter for transmitting the interrogation pulses and an electroacoustic receiver for receiving the acoustic response pulses as well as a signal processing unit for determining the instantaneous position of the underwater vehicle (11) using the response pulses which have been converted into electrical received signals.

6. The device as claimed in claim 1, characterized in that a steering apparatus (20) which is arranged on the platform (13) and is intended to generate steering signals which can be transmitted, via a steering wire (21), preferably a glass fiber cable, to the underwater vehicle (11) is connected to the tracking apparatus (15) and continuously compares the instantaneous positions of the underwater vehicle (11), which are determined by the tracking apparatus (15), with a position (which is stored in it) of an underwater object and uses the differences in position to generate steering signals which guide the underwater vehicle (11) to the underwater object.

7. A method for tracking an underwater vehicle (11), in which sound pulses which are transmitted by the underwater vehicle (11) are received in a submerged platform (13) and are converted into electrical received signals and the instantaneous position of the underwater vehicle (11) is continuously determined using the electrical received signals, characterized in that the submerged position of the platform (13) is spatially stabilized using controlled maneuver drives (18, 19) which act horizontally and vertically.

8. The method as claimed in claim 7, characterized in that the underwater vehicle (11), together with the platform (13), is inserted into the water from a carrier vehicle (10) and the underwater vehicle (11) is started from the platform (13).

9. The method as claimed in claim 8, characterized in that the platform (13) and the carrier vehicle (10) are connected to a cable (17), and in that the cable (17) is used to lower and retrieve the platform (13) and/or to interchange data between the platform (13) and the carrier vehicle (10).

10. The method as claimed in claim 7, characterized in that the sound pulses which are transmitted by the underwater vehicle (11) are triggered by electrical or acoustic sound pulses which are transmitted from the platform (13).
